(19) United States
(12) Patent Application Publication
(10) Pub. No.: US 2025/0063048 A1
(43) Pub. Date: Feb. 20, 2025

(54) INFORMATION PROCESSING APPARATUS, INFORMATION PROCESSING METHOD, AND NON-TRANSITORY COMPUTER READABLE MEDIUM

(71) Applicant: NEC Corporation, Minato-ku, Tokyo (JP)

(72) Inventors: Shohei MITANI, Tokyo (JP); Hirofumi Ueda, Tokyo (JP)

(73) Assignee: NEC Corporation, Minato-ku, Tokyo (JP)

(21) Appl. No.: 18/723,978

(22) PCT Filed: Jan. 26, 2022
(86) PCT No.: PCT/JP2022/002788

§ 371 Date: Jun. 25, 2024

(51) Int. Cl. H04L 9/40

(52) U.S. Cl. CPC H04L 63/10

(57) ABSTRACT

An information processing apparatus according to an example embodiment of the present disclosure includes at least one memory configured to store instructions; and at least one processor configured to execute the instructions to: acquire a data set in which a plurality of combinations of a pattern of a plurality of elements indicating an access attribute and an access control action associated with the pattern of the elements are defined and request a user to input an action associated with a pattern of an element not covered by the data set in a case in which the data set does not cover an action associated with one or more assumed patterns of an element.

### TECHNICAL FIELD

The present invention relates to an information processing apparatus, an information processing method, and a non-transitory computer readable medium.

### BACKGROUND ART

Access control in a network is crucial for securing network security and necessary access.

For example, cited Patent Literature 1 discloses a system that generates an access control list by using a plurality of resource descriptions and a policy execution point graph for a network as a method for dynamically generating an access control list of a network.

### CITATION LIST

### Patent Literature

Patent Literature 1: Published Japanese Translation of PCT International Publication for Patent Application, No. 2018-536363

### SUMMARY OF INVENTION

### Technical Problem

It is an object of the present disclosure to provide an information processing apparatus, an information processing method, and a non-transitory computer readable medium which are capable of contributing to accurately deciding an access control action.

### Solution to Problem

An information processing apparatus according to an example embodiment includes an acquisition means that acquires a data set in which a plurality of combinations of a pattern of a plurality of elements indicating an access attribute and an access control action associated with the pattern of the elements are defined and a request means that requests a user to input an action associated with a pattern of an element not covered by the data set in a case in which the data set does not cover an action associated with one or more assumed patterns of an element.

An information processing method according to an example embodiment includes acquiring, by a computer, a data set in which a plurality of combinations of a pattern of a plurality of elements indicating an access attribute and an access control action associated with the pattern of the elements are defined, and requesting, by the computer, a user to input an action associated with a pattern of an element not covered by the data set in a case in which the data set does not cover an action associated with one or more assumed patterns of an element.

A non-transitory computer readable medium according to an example embodiment has a program stored therein, and the program causes a computer to execute acquiring a data set in which a plurality of combinations of a pattern of a plurality of elements indicating an access attribute and an access control action associated with the pattern of the elements are defined, and requesting a user to input an action associated with a pattern of an element not covered by the data set in a case in which the data set does not cover an action associated with one or more assumed patterns of an element.

### Advantageous Effects of Invention

According to the present disclosure, it is possible to provide an information processing apparatus, an information processing method, and a non-transitory computer readable medium which are capable of contributing to accurately deciding an access control action.

### BRIEF DESCRIPTION OF DRAWINGS

FIG. 1 is a block diagram illustrating an example of an information processing apparatus according to a first example embodiment.

FIG. 2 is a flowchart illustrating an example of a process of the information processing apparatus according to the first example embodiment.

FIG. 3 is a block diagram illustrating an example of a policy generation system according to a second example embodiment.

FIG. 4A is a conceptual diagram illustrating a process performed by an additional information request unit according to the second example embodiment.

FIG. 4B is a conceptual diagram illustrating a process performed by the additional information request unit according to the second example embodiment.

FIG. 4C is a conceptual diagram illustrating a process performed by the additional information request unit according to the second example embodiment.

FIG. 4D is a conceptual diagram illustrating a process performed by the additional information request unit according to the second example embodiment.

FIG. 5 is a block diagram illustrating an example of a hardware configuration of an apparatus according to each example embodiment.

### EXAMPLE EMBODIMENT

Hereinafter, example embodiments of the present invention will be described with reference to the drawings. Note that, in the description and drawings to be described below, omission and simplification are made as appropriate for clarity of description. Further, in the present disclosure, unless otherwise specified, in a case in which “at least one” is defined for a plurality of items, the definition may mean any one item or may mean any two or more items (including all items).

### First Example Embodiment

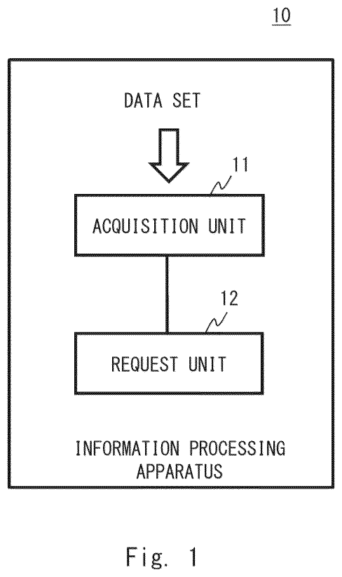

FIG. 1 is a block diagram illustrating an example of an information processing apparatus. The information processing apparatus 10 includes an acquisition unit 11 and a request unit 12. Each unit (each means) of the information processing apparatus 10 is controlled by a control unit (controller) (not illustrated). Each unit will be described below.

The acquisition unit 11 acquires a data set in which a plurality of combinations of a pattern including a plurality of elements indicating an access attribute (hereinafter, also simply referred to as a pattern) and an access control action associated with the pattern are defined. Note that the acquisition unit 11 includes an interface that acquires information from the inside or outside of the information processing apparatus 10. The acquisition process may be automatically executed by the acquisition unit 11 or may be performed by manual input.

Here, the “element indicating the access attribute” indicates any element specifying a property of access. Specific examples of the element may include any one or more pieces of specific information (values) related to the property of access, such as (1) various types of data of an access source, (2) various types of data of an access destination, and (3) other data indicating the property of access.

Specific examples of (1) various types of data of the access source include any one or more items among information regarding an ID of the access source, information regarding a user, information regarding a device of the access source, information regarding an Internet Protocol (IP) address of the access source, information regarding a port number, a software name (for example, an application name), an access authentication means, and the like. Here, the information regarding the ID of the access source includes any one or more pieces of information among an ID of the access source (user ID), a user name, a device ID, an application ID, a user authentication result (authentication history) of the ID of the access source, and the like. The information regarding the user includes any one or more pieces of information among an affiliation (organization), a title, and a job category of the user, a user position (a position of a device which is an access source), and the like. The information regarding the device of the access source includes any one or more among operation system (OS) used by the device of the access source, and a manufacturer name. The information regarding the IP address of the access source includes any one or more pieces of information among the IP address of the access source, the risk level of the IP address of the access source, and the like.

Specific examples of (2) various types of data of the access destination include any one or more pieces of information among information regarding an ID of the access destination, information regarding data of the access destination, an IP address of the access destination, information regarding an OS used by the device of the access destination, an operation type, and the like. The information regarding the ID of the access destination includes any one or more pieces of information among a resource ID of the access destination, an owner name of the resource ID of the access destination, and the like. The information regarding the data of the access destination includes any one or more pieces of information among an organization of the access destination (an organization having a resource), a type of data (resource) of the requested access destination, a creator, a creation date and time, a security level, and the like.

Specific examples of (3) other data indicating the property of access include any one or more pieces of data among a request frequency from the ID of the access source to the resource ID of the access destination, an access time zone (or time), a session key scheme, the degree of abnormality, encryption strength of traffic, various types of data regarding authentication, and the like. The various types of data regarding the authentication include any one or more pieces of data among various types of authentication methods (including, for example, information on authentication strength), device authentication results, application authentication results, various types of authentication times, the number of failures of various types of authentication, and the like. However, the elements described above are merely examples, and the elements indicating the access attribute are not limited thereto.

A “plurality of patterns indicating the access attribute” mean that two or more of these elements are present. For example, X, Y, and Z are assumed as the access attribute, X1 and X2 are assumed as elements of different values of the same attribute X, Y1 and Y2 are assumed as elements of different values of the same attribute Y, and Z1 and Z2 are assumed as elements of different values of the same attribute Z. In this case, any one or more patterns among “X1, Y1”, “X1, Z1”, “Y1, Z1”, “X1, Y2”, . . . “X1, Y1, Z1”, . . . “X2, Y2, Z2” are included as the “pattern indicating the access attribute”.

The data set further includes access control actions which are associated with the respective patterns. Different actions of two or more steps are defined as the actions. For example, two or more types of actions among approval, denial, and conditional approval (additional approval required) may be defined as the actions. However, the actions described above are merely examples, and the types of actions are not limited thereto.

In the data set, a plurality of combinations of the pattern indicating the access attribute described above and the access control action respectively associated with the patterns are defined. For example, in a case in which there are “X1, Y1”, “X1, Z1”, and “Y1, Z1” as the patterns indicating the access attribute, and there are “approval”, “denial”, and “approval” as the actions associated with the respective patterns, “X1, Y1→approval”, “X1, Z1→denial”, and “Y1, Z1→approval” are defined in the data set as the combinations thereof.

In a case in which the data set acquired by the acquisition unit 11 does not cover the actions associated with one or more assumed patterns, the request unit 12 requests the user to input one or more actions associated with the patterns of the elements not covered by the data set. Here, the “one or more assumed patterns” may be one or more patterns that can be theoretically taken for each defined element. Alternatively, one or more patterns that can be practically taken may be included among the patterns that can be theoretically taken depending on conditions on the system.

As the “one or more assumed patterns” described above, for example, a specific pattern which is set in advance for reasons such as frequent appearance or importance in access control can be considered. Here, the request unit 12 may request the user to input an action associated with a non-covered pattern in a case in which the data set does not cover the number of patterns equal to or more than a predetermined threshold value or ratio among one or more specific patterns. For example, even if one of the specific patterns is not covered by the data set, the request unit 12 may request the user to input an action associated with the non-covered pattern. As another example, different weightings may be performed in advance in a plurality of specific patterns. In this case, the request unit 12 calculates at least one of a numerical value calculated on the basis of the weighting of the pattern covered by the data set or a numerical value calculated on the basis of the weighting of the pattern not covered by the data set in a plurality of specific patterns. Then, at least one of these numerical values can be used to decide whether to request the user to input an action associated with the pattern not covered by the data set.

Further, the “one or more assumed patterns” described above may be all assumed patterns. Here, the “all assumed patterns” may be all patterns that can be theoretically taken for each defined element, or may be all patterns that can be taken practically and are limited from all the patterns depending on conditions on the system.

Further, the “non-covered pattern” means that an action associated with the pattern is not finally decided, or that a constraint condition to be described later in the second example embodiment is not defined for the action.

At this time, the request unit 12 may determine that the data set does not cover an action associated with one or more assumed patterns by comparing the data set with one or more assumed patterns. Alternatively, another processing unit of the information processing apparatus 10 may execute the determination by comparing the two. In the determination, whether there is a pattern not defined in the data set in one or more assumed patterns is analyzed. The request unit 12 requests the user to input an action on the basis of the determination result. The input action is one of the different actions of two or more steps.

Note that, even in a case in which the data set does not cover the actions associated with one or more assumed patterns as a result of comparison, when a predetermined condition is satisfied, the request unit 12 may not request the user to input an action. As an example, there is a case in which all the assumed patterns which are not covered can be covered by similar patterns. For example, in a case in which an action is defined for the access attributes X (X1 or X2), Y (Y1 or Y2), and Z (Z1 or Z2) described above, when an action for two patterns of “X1, Y1, Z1” and “X2, Y2, Z2” is defined, an action associated with a closer pattern of the two patterns can be defined even though the other six patterns configured with X, Y, and Z are not directly covered. A more practical condition will be described later in the second example embodiment.

In addition, the number of actions which are requested to be input by the request unit 12 and the number of times of input requests are any numbers of 1 or more. This will be described later in detail in the second example embodiment.

As a method of requesting the user to input an action, the request unit 12 can visualize and output the request to input an action by using the interface which is included in the information processing apparatus 10 or connected to the information processing apparatus 10. For example, the request unit 12 can cause information of an intention to be displayed on a screen which is an interface or can cause information of an intention to be printed by a printing device which is an interface.

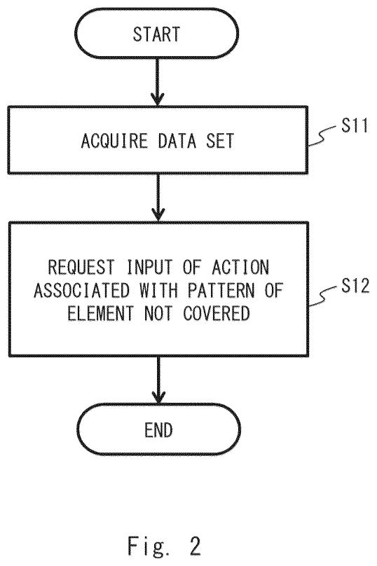

FIG. 2 is a flowchart illustrating an example of a representative process of the information processing apparatus 10, and the process of the information processing apparatus 10 will be described with this flowchart. First, the acquisition unit 11 of the information processing apparatus 10 acquires the data set in which a plurality of combinations of a plurality of patterns indicating the access attribute and the access control actions associated with the patterns are defined (step S11: acquisition step). Next, in a case in which the data set does not cover the action associated with one or more assumed patterns, the request unit 12 requests the user to input the action associated with the pattern not covered by the data set (step S12: request step). As described above, as the user is caused to input the action associated with the pattern not covered by the data set, it is possible to accurately decide the access control action for any pattern by using not only the data set but also information of the combination of the pattern and the action.

### Second Example Embodiment

Hereinafter, example embodiments of the present invention will be described with reference to the drawings. The second example embodiment discloses a specific example of the information processing apparatus 10 described in the first example embodiment.

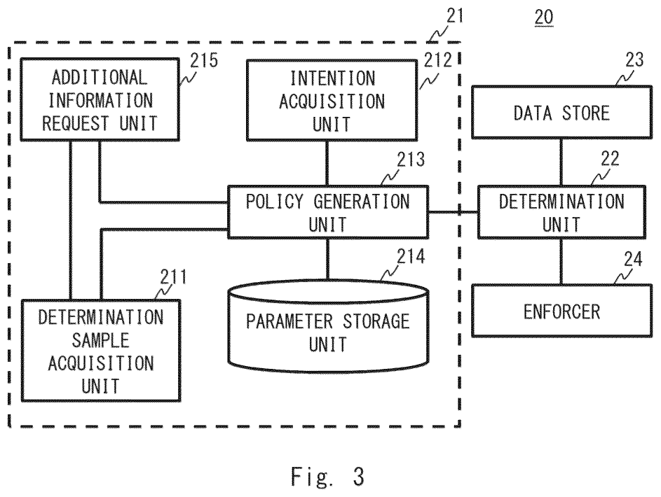

FIG. 3 is a block diagram illustrating an example of an access control system 20 that performs an access control determination over a zero trust network. The access control system 20 includes a policy generation system 21, a determination unit 22, a data store 23, and an enforcer 24. The details of each unit will be described below.

The policy generation system 21 is equivalent to a specific example of the information processing apparatus 10 according to the first example embodiment. The policy generation system 21 generates an access control policy for access control on the basis of an input intention (knowledge necessary for policy generation) and a determination sample (equivalent to the data set in the first example embodiment), and outputs the generated access control policy to the determination unit 22. The details of the policy generation system 21 will be described later.

Here, the access control policy is a policy in which a plurality of combinations of one or more patterns indicating an access attribute and an access control action associated with the one or more patterns are defined. As a specific example, in a case in which a combination of elements is (affiliation of the user of the access source: division A, job category: developer, authentication method: two-step authentication, organization having a resource: division A, resource type: design document), an action associated therewith is defined as “approval” in the access control policy.

When an access control inquiry (request) is made using the access control policy acquired from the policy generation system 21, the determination unit 22 determines an access control action on the basis of an element related to the request. The element related to the request means the same element as the element indicating the access attribute described in the first example embodiment.

Specifically, (i) information of the element indicating the access attribute included in the request and (ii) other information of a background attribute are input to the determination unit 22 as the elements related to the request. As an example of the information of (i), the ID of the access source, the IP address of the access source, the resource ID of the access destination, an operation type, a session key, and the like are assumed, but the information of the element included in the request is not limited thereto. Further, as an example of the information of (ii), the user name of the ID of the access source, an affiliation, the title or the job category of the user, the manufacturer name of the device, the user position, the user authentication result, the risk level of the IP address of the access source, the owner name of the resource ID of the access destination, the type and creation date and time of the data of the access destination, the encryption strength, the request frequency from the ID of the access source to the resource ID of the access destination, the time of access, various types of authentication methods, the device authentication result, the application authentication result, various types of authentication times, the number of failures of various types of authentication, and the like are assumed, but the information of the element included in the information of the background attribute is not limited thereto.

The determination unit 22 compares the element related to the request with a combination of a plurality of elements defined in the access control policy, and specifies a combination of elements defined in the access control policy that satisfies the condition of the element related to the request. Then, the action defined in association with each combination is decided as the action for the request, and information of the action is output.

The actions that can be taken in the second example embodiment are approval, an additional authentication request, denial, and the like, but are not limited thereto. For example, transfer of access to a server that performs a more detailed check, an approval request to an administrator, or the like can be considered as the action. This action constitutes the totally ordered set that satisfies the reflexive law, the transitive law, the asymmetric law, and the perfect law. Furthermore, in the present example embodiment, the totally ordered set indicating the degree of influence on the action is defined for the pattern. Here, directivity toward “approval” or “denial” is defined as the “order of the degree of influence”, and information indicating the degree of movement to “approval” or “denial” is defined as the “magnitude of the degree of influence”.

The determination unit 22 described above can be implemented by any means such as a proxy server for access control, an application gateway, or attribute-based encryption.

The data store 23 is a storage (storage unit) that stores the information of the background attributes used in the determination unit 22 described above. The access control system 20 stores automatically collected data in the data store 23. In a case in which there is an access control request, the determination unit 22 acquires the information of the background attribute associated with the request with reference to the data store 23.

The enforcer 24 is an access control device, and outputs the information of the element related to the request to the determination unit 22 upon receiving the access control request. Then, information of the action decided by the determination unit 22 is acquired, and access control for the request is executed on the basis of the information of the action. In a case in which access is approved, the enforcer 24 forwards the packet for access to the resource (access destination), and in a case in which access is denied, the enforcer 24 discards the packet for access. As described above, the access control system 20 performs the access control based on the generated access control policy.

Next, the details of the policy generation system 21 will be described. As illustrated in FIG. 3, the policy generation system 21 includes a determination sample acquisition unit 211, an intention acquisition unit 212, a policy generation unit 213, a parameter storage unit 214, and an additional information request unit 215. Each unit will be described below.

The determination sample acquisition unit 211 acquires a determination sample and outputs the determination sample to the policy generation unit 213. The determination sample includes a plurality of sample policies defined by the user (or an existing automation technique). In the sample policy, a plurality of correspondence relationships between the patterns of a plurality of elements indicating the access attribute (hereinafter, also referred to as a sample pattern) and the access control action for the sample pattern are defined. However, in the sample policy, a correspondence relationship between one element and the access control action for the element may be defined as another correspondence relationship.

Here, a plurality of sample policies may be defined for each individual policy from different viewpoints. For example, the elements such as the encryption strength of traffic, the OS version of the device of the access source, the application authentication result, the authentication strength of the user, the creator of the resource, and the type of resource may be set as the viewpoint based on the security function. Further, the elements such as the title and affiliation of the user (for example, an assigned project), the creator of the resource, the type of resource, and the user position may be set as a viewpoint based on a department structure (affiliation, title, and the like) of an organization in access. As described above, the different viewpoints may have different elements or the same elements. A specific example of the sample policy is “the affiliation and title of the user, the authentication means, the position of the device, the OS, the type of data (request data) of access destination requested, the application name→approval/denial”.

Further, the sample policy may be expressed in a format in which some of the elements are hardly uniquely specified (That is, “anonymized”). For example, the affiliation of the user in the sample policy is expressed as “human resources department” and “development department” in the non-anonymized state, whereas the affiliation is expressed as “department A” and “department B” in the anonymized state. For example, the anonymization is performed to protect confidential information of the organization when the sample policy is presented to a person or system outside the organization. Alternatively, it is also assumed that the anonymization is performed because originally, in generating the sample policy, an element of underlying data is not uniquely specified (for example, the readability of the underlying data is low).

The determination sample acquisition unit 211 may output the acquired determination sample to the policy generation unit 213 without change. Alternatively, the determination sample acquisition unit 211 may further acquire data indicating ideal access control for a specific pattern and output the data to the policy generation unit 213. The number of patterns included in this data may be, for example, about a few to several tens of patterns, but is not limited thereto. Accordingly, the accuracy of the policy generated by the policy generation unit 213 can be further improved.

The intention acquisition unit 212 acquires an intention assumed to be used by a decision maker in deciding an action on the basis of one or more elements. The intention means knowledge necessary for policy generation as described above, and more specifically, includes a pattern of one or more elements indicating an access attribute.

The intention acquisition unit 212 may acquire, as the intention, an intention in which at least one of the order and the magnitude of the degree of influence that affects the action is further defined in association with the pattern of one or more elements. Further, as described later, the intention is allowed to be defined in an ambiguous format. The intention acquisition unit 212 can acquire any number of combinations which is equal to or more than 1.

As an example of the pattern of one or more elements, a set of “the affiliation of the user, the type of request data, or the organization having the resource”, a set of “the OS, the software name, or the application name”, a single “authentication means”, the “degree of abnormality”, and the like can be considered. For example, in the access control, it is considered that the type of data or the organization having the resource to be allowed to be accessed is considered to differ depending on the affiliation of the user. Therefore, “the affiliation of the user, the type of request data, or the organization having the resource” may be defined as the element of intention. Similarly, in the access control, it is considered that the security level of the access can change (that is, the approval or denial of access may change) depending on the combination of the OS of the access source and the software or the application, the authentication means, and the degree of abnormality, thus “the OS, the software name, or the application name”, “the authentication means”, and “the degree of abnormality” may be defined as the elements of the intention.

Further, the information of the degree of influence that affects the action is information indicating how much the action moves in the direction of “approval” or “denial”. As described above, the directivity toward “approval” or “denial” is defined as the “order of the degree of influence”, and information indicating the degree of movement to “approval” or “denial” is defined as the “magnitude of the degree of influence”. For example, the “order of the degree of influence” is obtained by arranging the “magnitudes of the degrees of influence” in descending order. The information of the degree of influence does not necessarily indicate the action to be executed itself.

Here, as the degree of influence in the intention, the intention acquisition unit 212 may acquire data such as a numerical value which is quantitatively expressed, or may acquire information of a qualitative (ambiguous) format. A specific example of the latter is, for example, information indicating that “affiliation of the user: development department, request data: design data” is greater than “affiliation of the user: development department, request data: personnel data” with respect to the directionality in which the action is directed towards “approval”. The reason why this information can be defined is that it is generally natural that the user belonging to the development department requests data (for example, design data) associated with product development, and it is considered appropriate that the access control related to the data is approved. On the other hand, in a case in which the user belonging to the development department is developing the human resources system, it may be appropriate to approve access to personnel data for the purpose of development. Therefore, the degree of influence is qualitative information indicating a general tendency, unlike information of a quantitative form indicating whether to actually approve or deny. Note that the magnitude of the degree of influence may be expressed with three or more steps (for example, it can be expressed as the “degree of influence is large”, the “degree of influence is slightly large”, and the “degree of influence is small” in descending order of the degree of influence) instead of two steps.

In a case in which the qualitative information of the degree of influence is acquired, the intention acquisition unit 212 may change the information of the degree of influence as a numerical value in which the order and magnitude of the degree of influence are defined, and then output the information to the policy generation unit 213. For example, in a case in which a positive score is assigned as the directivity of “approval”, since “affiliation of the user: development department, request data: design data” is more likely to be approved for the action than “affiliation of the user: development department, request data: personnel data”, the intention acquisition unit 212 may assign the numerical value of the degree of influence “1” to the former and the numerical value of the degree of influence “0” to the latter.

The intention acquisition unit 212 outputs the information of the acquired intention to the policy generation unit 213 as described above.

The policy generation unit 213 acquires the determination sample from the determination sample acquisition unit 211, and acquires the information of the intention from the intention acquisition unit 212. Then, the determination sample and the information of the extracted intention are input to an access control policy generation model (hereinafter, referred to as a policy generation model), and the policy generation model is trained to perform machine learning, and thus the access control policy that enables the output of the access control action according to the input intention is generated and output by the policy generation model. The access control policy is defined by the combination of the pattern of one or more elements indicating the access attribute and the action. The pattern of the element included in the access control policy may be a pattern including the sample pattern defined by the sample policy and the pattern of the element defined by the information of the intention.

The policy generation model can emulate a method in which an administrator or the like of the network subject to the access control decides the sample policy on the basis of the acquired intention, and decide in detail the pattern of the combination of elements and the combination of actions which are not clearly defined by the sample policy (which are, for example, ignored because they are out of the range or do not substantially affect the access control determination). Here, the policy generation model can automatically adjust the order and magnitude of the degree of influence associated with the combination of the elements based on the intention and set appropriate values thereto.

In detail, the policy generation model can generate the access control policy so that the information (order and magnitude) of the degree of influence associated with the pattern of the element acquired from the intention acquisition unit 212 is stored. That is, a quantitative action in a fourth pattern defined in the access control policy can be made not to be contradictory to the qualitative information of degree of influence acquired from the intention acquisition unit 212. Then, as an example, the generated access control policy may uniquely specify an anonymized location in the sample policy.

The policy generation unit 213 described above can be implemented by any means such as probabilistic logic, fuzzy logic, linear regression, support vector machines, decision trees, neural networks, monotonic regression, monotonic decision trees, and monotonic neural networks.

Further, the policy generation unit 213 may generate some sort of algorithm (for example, program) instead of the access control policy. In a case in which a pattern of a plurality of elements indicating a predetermined (for example, requested) access attribute is input, this program outputs an action associated with the pattern. The policy generation unit 213 outputs the program to the determination unit 22, and the determination unit 22 determines an action for the request using the program.

Further, the policy generation unit 213 derives a pattern of one or more assumed elements by using the information of the intention acquired from the intention acquisition unit 212. Then, it is determined whether all of one or more assumed patterns are covered in the determination sample acquired from the determination sample acquisition unit 211. In a case in which all of one or more assumed patterns are not covered in the determination sample, the policy generation unit 213 outputs information of one or more patterns that are not covered to the additional information request unit 215 as a process execution instruction together with the determination sample and the information of the intention acquired so far. In response to this output, the additional information request unit 215 executes an input request to the user as described later.

Note that, for example, the “one or more assumed patterns” may be a specific pattern which is set in advance for reasons such as frequent occurrence or importance in the access control, or may be all assumed patterns. Since the details have been described in the first example embodiment, the description thereof will be omitted.

In a case in which all of one or more assumed patterns are covered in the determination sample, the policy generation unit 213 does not output the process execution instruction to the additional information request unit 215. Therefore, the additional information request unit 215 does not execute a process to be described later. Further, even in a case in which all of one or more assumed patterns are not covered in the determination sample, for example, in the following cases, the policy generation unit 213 may not output the process execution instruction to the additional information request unit 215.
(A) A case in which, in the access control policy that can be generated on the basis of the information acquired so far, the number of non-covered patterns or the ratio of the number of non-covered patterns to the number of one or more assumed patterns is less than a predetermined threshold value.
(B) A case in which the reliability in the access control policy that can be generated on the basis of the information acquired so far is equal to or greater than a predetermined threshold value.

Here, the “information acquired so far” refers to the determination sample acquired by the determination sample acquisition unit 211, the information of the intention acquired from the intention acquisition unit 212, and the information of the action finally decided by the input requests made so far and the pattern associated therewith. Further, the reliability of the access control policy means a probability (accuracy) that the access control policy can decide a correct action for one or more assumed patterns.

Note that the condition of (A) can also be read as “a case in which, in the access control policy that can be generated on the basis of the information acquired so far, the number of covered patterns or the ratio of the number of covered patterns to the number of one or more assumed patterns is equal to or more than a predetermined threshold value”. Further, in (A), instead of the number of non-covered patterns (or the number of covered patterns), the number of patterns for which a constraint condition is not finally decided (or the number of patterns for which a constraint condition is finally decided) may be used. The constraint condition will be described later.

Further, the policy generation unit 213 can also acquire the additional information (the information of the action), which is requested to be input as a result of the process of the additional information request unit 215 and input by the user, and the information of the pattern of the element associated therewith. The policy generation unit 213 trains the policy generation model to perform machine learning by causing the information to be input to the access control policy generation model together with the determination sample and the information of the intention acquired so far. Accordingly, the policy generation unit 213 can increase the accuracy of the generated policy. Further, since the policy generation unit 213 can use the newly input additional information each time the input request is made, the accuracy of the generated policy can be improved each time.

Further, the policy generation unit 213 can generate the access control policy so that the totally ordered set associated with the pattern and the totally ordered set associated with the action become order-isomorphic (monotonic). That is, the policy generation unit 213 can generate the access control policy in which, in a case in which the pattern changes to be in the direction of “approval” or “denial”, the action associated therewith changes to be in the direction of “approval” or “denial”.

The parameter storage unit 214 stores parameters necessary for the policy generation unit 213 to generate the access control policy. The policy generation unit 213 acquires the parameters from the parameter storage unit 214 when generating the access control policy.

The additional information request unit 215 is equivalent to the request unit 12 of the first example embodiment. The additional information request unit 215 acquires, from the policy generation unit 213, the determination sample and the information of the intention acquired so far and the information of the pattern not covered in the determination sample together with the process execution instruction. The additional information request unit 215 can determine that the non-covered pattern is a pattern which requires additional information, and can ask (generate a query) the user about the action associated with the pattern. Here, the additional information request unit 215 causes the input of the action to be requested to be displayed on the screen to which the policy generation system 21 is connected, thereby performing the input request of the action as the additional information to the user. The input action information is input from the determination sample acquisition unit 211 and acquired by the policy generation unit 213 and the additional information request unit 215.

Note that, in a case in which there are a plurality of patterns of elements not covered by the determination sample, the additional information request unit 215 may request input of an action for only one pattern among a plurality of patterns, or may request input of an action for a plurality of patterns. In a case in which the input of an action for a plurality of patterns is requested, the additional information request unit 215 may request input of an action for a plurality of patterns in a single input request, or may sequentially request input of an action for a plurality of patterns by a plurality of input requests having different time series. At this time, the number of patterns of the elements for which the input of the action is requested by a single input request may be one or more.

In a case in which there are a plurality of (N) patterns not covered by the determination sample, the additional information request unit 215 can specify one or more of (less than N) patterns of elements not covered by the determination sample, among which it is particularly convenient to specify an action, as a target for which the input of an action is requested. The pattern specified as the request target enables the policy generation unit 213 to generate a highly accurate policy as an associated action is finally decided.

For example, the additional information request unit 215 can determine the degree of importance of final action decision in a plurality of non-covered patterns for each pattern, and request the user to input at least an action associated with a pattern of an element having the highest degree of importance. Alternatively, the additional information request unit 215 may request the user to input an action associated with one or more patterns having the degree of importance equal to or greater than a predetermined threshold value among the determined patterns. The additional information request unit 215 can decide the level of the degree of importance according to the following criteria.

As an example, assumed is a case in which, in patterns of first and second elements which are not covered by the determination sample, when an action associated with the pattern of the first element is finally decided, the constraint condition of the action of the pattern of the second element is determined, but the reverse does not hold true. In this case, the additional information request unit 215 determines that the pattern of the first element is higher in the degree of importance than the pattern of the second element.

Here, the decision of the constraint condition of the action of the pattern of the second element may indicate that the action of the pattern of the second element is finally decided, or may indicate that the probability that the action of the pattern of the second element is decided is defined. For example, in a case in which the action associated with the pattern of the first element is not finally decided, it is assumed that it is uncertain which of “approval, additional authentication request, and denial” is the action associated with the pattern of the second element. Here, when the action associated with the pattern of the first element is finally decided, as an example of the constraint condition, assumed is a case in which the probability that the action associated with the pattern of the second element would be “approval” is 80%, the probability that the action would be “additional authentication request” is 10%, and the probability that the action would be “denial” is 10%.

The additional information request unit 215 decides the degree of importance by analyzing the degree of decision of the constraint condition of the action of other patterns in a case in which each action is finally decided for one or more patterns of the elements not covered by the determination sample. Then, it is possible to request the user to input the action for the pattern of the element having the highest degree of importance or the pattern of the element having the degree of importance within a predetermined ranking from the top. As an example of definition of the pattern having the high degree of importance level, the following pattern is assumed.
(C) In a case in which content of the action associated with a certain pattern is finally decided by the input request, the degree of importance of the pattern of the element increases as the number of patterns in which the action is finally decided (newly covered) among the patterns not covered so far, on the basis of the acquirable information increases.

Here, the “acquirable information” refers to information of the determination sample acquired by the determination sample acquisition unit 211, and information of the action finally decided by the current input request (including previous input request in the case of the second and subsequent input requests) and the pattern associated therewith. Further, the “pattern not covered so far” is a pattern not covered by the determination sample acquired by the determination sample acquisition unit 211 in a case in which the additional information is requested by the first input request. In a case in which the additional information is requested by the second and subsequent input requests, it is a pattern not covered by the acquired determination sample and the information of the action input from the user by the previous input request and the pattern associated therewith.

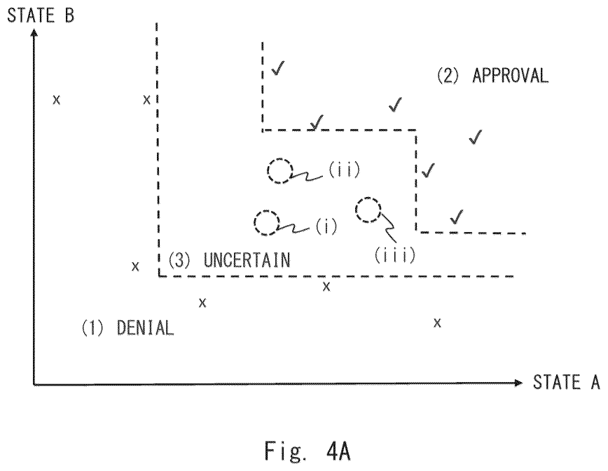

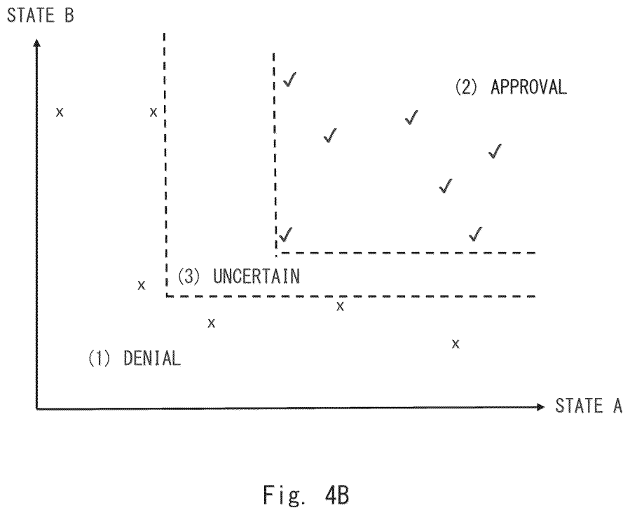

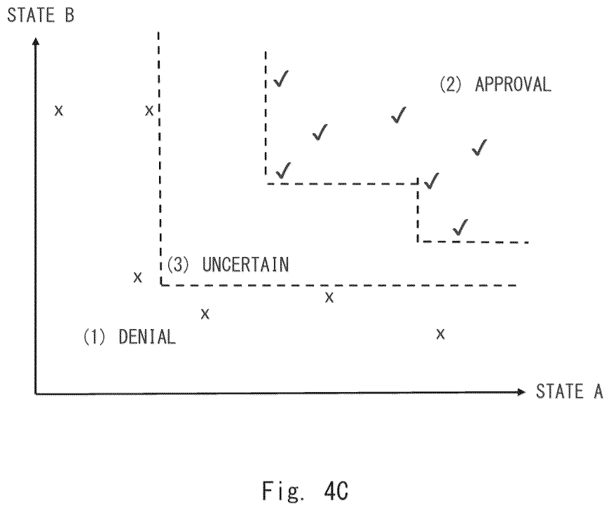

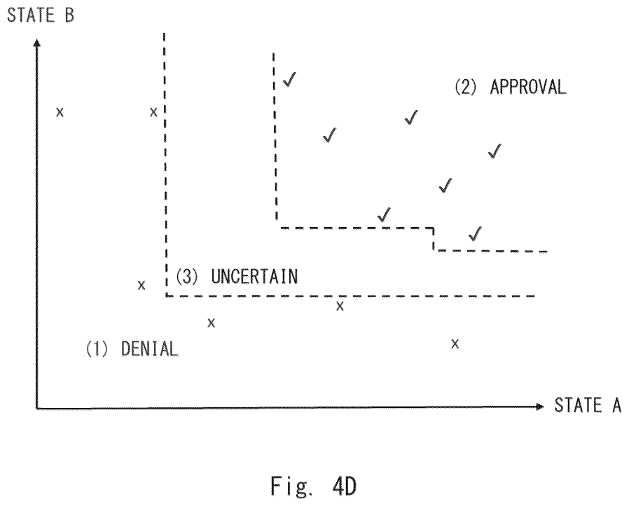

FIG. 4A is a schematic diagram illustrating a method for (A). The horizontal axis in FIG. 4A indicates a state A (for example, OS information) set by one or more elements, and the vertical axis indicates a state B (for example, affiliation of the user and data of the access destination) set by one or more elements different from the state A. FIG. 4A is a graph illustrating a final decision situation of an action for one or more assumed patterns (in this example, all assumed patterns). In detail, in a case in which the states A and B are in a (1) denial area, the action is finally decided as “denial”, and in a case in which the states A and B are in a (2) approval area, the action is finally decided as “approval”. Then, in a case in which the states A and B are in a (3) uncertain region, the action is not finally decided.

In FIG. 4A, (i), (ii), and (iii) are assumed as the patterns for requesting input of an action by the next input request. (i) is a pattern of the states A1 and B1, (ii) is a pattern of the states A2 and B2, and (iii) is a pattern of the states A3 and B3. In a case in which (A) is adopted as the definition of the pattern with the high degree of importance, the additional information request unit 215 analyzes a pattern that increases the number of patterns to be newly covered when the action is finally decided as “approval” for (i) to (iii).

FIGS. 4B to 4D illustrate transitions of the (2) approval region and the (3) uncertain region when an action is finally decided as “approval” for each of (i) to (iii). Comparing FIGS. 4B to 4D, as illustrated in FIG. 4B, in a case in which the action is finally decided for the pattern of (i), the (2) approval region expands the most, and conversely, the (3) uncertain region narrows down. Therefore, the additional information request unit 215 determines that the pattern of (i) has the maximum number of patterns to be newly covered and has the highest degree of importance. Therefore, the additional information request unit 215 requests the user to input the action for the patterns of the states A1 and B1 of (i).

Note that, in this example, two types of sets of the states A and B are assumed as the states, but the additional information request unit 215 can also execute a similar process on N types of sets (N: natural number) represented by N dimensions.

Note that, in (C), instead of the number of patterns to be newly covered, the ratio of the number of patterns to be newly covered to the number of one or more assumed patterns may be used. Further, in (C), instead of the number of patterns to be newly covered, the number of patterns in which the constraint condition is newly finally decided may be used.

As another example of definition of the pattern having the high degree of importance level, the following pattern is also assumed.
(D) In a case in which the content of the action associated with a certain pattern is finally decided by the input request, the degree of importance of the pattern increases as the reliability of the access control policy generated by the policy generation unit 213 increases, by using the determination sample, the action input by the input request, and the pattern associated therewith.

Here, the reliability of the access control policy means a probability (accuracy) that the access control policy can decide a correct action for one or more assumed patterns. Note that, in a case in which the reliability of the access control policy is equal to or greater than a predetermined threshold value when a certain pattern is determined, the additional information request unit 215 may increase the degree of importance of the pattern to be higher than the other patterns. One or more threshold values may be set as the threshold value.

Further, the additional information request unit 215 can change the pattern associated with the action which is requested to be input in the second input request (for example, after the second and subsequent input requests) which is later chronologically accordance with the content of the action input from the user by the first input request (for example, the first input request) which is earlier chronologically. This is because it is likely that the pattern having the higher degree of importance at the time of the second input request becomes different as the action and pattern finally decided by the first input request become different. The additional information request unit 215 requests input of the action for the pattern of the element having the highest degree of importance or the pattern of the element having the degree of importance within a predetermined ranking from the top at each input request time point.

As described above, in a case in which it is possible to change the pattern associated with the action which is requested to be input in the second input request in accordance with the content of the action input from the user by the first input request, the following pattern is also assumed as another example of the definition of the pattern with the high degree of importance.
(E) In a case in which content of an action associated with a pattern of a certain element is finally decided by the input request, the degree of importance of the pattern of the element increases as the number of input requests of the action, which is necessary in the future to increase the degree of the reliability of the access control policy defined in (D) to be equal to or greater than a predetermined threshold value, decreases.

The reliability of the access control policy has been described above. When the predetermined threshold value is 100%, in (E), a pattern of an element in which the number of input requests necessary for finally deciding the action for all of one or more assumed patterns becomes minimum is regarded as the pattern of the element with the highest degree of importance. Note that, in (E), the number of patterns of the action finally decided in a single input request may be a predetermined number (for example, 1).

The additional information request unit 215 can specify the degree of importance of (D) and (E) by using a Bayesian estimation technique.

In addition, the additional information request unit 215 can present information regarding the reliability of the access control policy that can be generated by the policy generation unit 213 to the user on the basis of the information which can be acquired up to now. The “information regarding the reliability” may mean, for example, the reliability of the access control policy that can be generated by the policy generation unit 213 in the current state, or may mean the number of pieces of additional information (input of an action) which is necessary for the reliability to reach a predetermined threshold value or more.

Further, the additional information request unit 215 may cause the presentation to the user and the input request to be displayed on the same screen, thereby presenting the user with information serving as a guide as to whether to input an action in response to the input request. That is, in a case in which the user determines, by looking at the presentation information, that the access control policy that can be generated at the present time point has the sufficient reliability, even though the input request is made for the pattern not covered by the access control policy, the user does not need to perform input of the action related to the input request. In this case, the user outputs an instruction to the access control system 20 to generate the access control policy by using information acquired so far. In response to this instruction, the policy generation unit 213 generates the access control policy by using the information acquired so far. The details thereof have been described above.

The policy generation of the policy generation system 21 described above is performed before the access control determination by the determination unit 22 starts. Accordingly, the determination unit 22 can accurately execute the access control determination by using the generated policy.

In recent years, with the progress of technology of the zero trust network, the importance of access control in the network has increased. The zero trust network can be applied, for example, in local 5th Generation (5G) used in companies, a municipalities, and the like.

The zero trust network computes a score related to security for access from all devices, and decides whether to permit the access. Accordingly, even though a threat intrudes into the network, it is possible to prevent the threat from accessing important files and to prevent spread of damage. In addition, the zero trust network performs the determination based on the score calculation described above without generally blocking access from the outside of the network, and thus can permit reliable access. Therefore, both safety and availability of the network can be achieved.

In the zero trust network, a policy engine of the network determines approval or denial of access by integrating various information based on viewpoints such as risk, need, trust, etc. In order to accurately determine approval or denial of access, it is necessary to generate a detailed policy. Further, it is desirable that the policy to be generated is dynamic in order to accurately reflect the environment change in the policy even when the environment of the network (a plurality of elements related to access control) changes. Therefore, the policy to be generated becomes complicated, and how to define or generate such a policy is a problem.

For example, in a case in which the administrator of the network subject to the access control generates a policy, the administrator may have more knowledge for a specific viewpoint (for example, a security function, a department structure, or the like) but less knowledge for other viewpoints. Therefore, the accuracy of the generated policy is degraded, and an access control action under various situations is unlikely to be accurately decided. A method in which a plurality of administrators each generates a policy and generates a policy in which the policies are integrated is also conceivable, but even in this case, the integrated policy hardly covers all of various situations, and definition omission in which an action cannot be accurately determined is likely to occur. For example, situations in which incomplete definition occurs in a part of the policy (a part is anonymized) as described above fall under such circumstances. In a case in which a person tries to review the definition in order to solve this problem, it is assumed that it takes a lot of time and effort.

On the other hand, in the second example embodiment, in a case in which the sample policy does not cover all the assumed patterns on the basis of the information of the intention, the additional information request unit 215 can request the user to input an action associated with the non-covered pattern. Therefore, it is possible to accurately decide the access control policy (increase the granularity) without requiring the user to review the access control policy. For example, in a case in which sample policy based on security and sample policy based on the performance are input to the determination sample acquisition unit 211 as the sample policies, the policy generation system 21 can generate the access control policy that further optimizes the tradeoff between security and performance. Further, since the information of the intention is used to determine the input request, the user can grasp the pattern which is not currently covered by the sample policy by the input request only by inputting the user's access control intention.

Further, in a case in which there are a plurality of patterns of elements not covered by the sample policy, the additional information request unit 215 can determine the degree of importance of final action decision in the pattern of each element not covered, and request the user to input at least an action associated with the pattern of the element with the highest degree of importance. Accordingly, the policy generation system 21 can further improve the accuracy of the access control policy in a single input request.

Further, in a case in which, in the patterns of the first and second elements not covered by the sample policy, the action associated with the pattern of the first element is finally decided, the constraint condition of the action of the pattern of the second element is decided, but the reverse does not hold true, the additional information request unit 215 may determine that the pattern of the first element is higher in the degree of importance than the pattern of the second element. Accordingly, the policy generation system 21 can further improve the accuracy of the access control policy in a single input request by determining the degree of importance of the pattern that has more influence on other patterns to be high and making it easier to request input for the action.

Further, the additional information request unit 215 may determine the degree of importance of the pattern of the element not covered on the basis of at least one of the number of patterns of the element covered by the sample policy, the action acquired by the input request to the user, and the pattern of the element associated therewith, the ratio of the number of patterns of the element covered to the number of one or more assumed patterns of the element, or the reliability of the access control policy generated using the sample policy, the action acquired by the input request to the user, and the pattern of the element associated therewith. Accordingly, the policy generation system 21 can further improve the accuracy of the access control policy in a single input request by determining the degree of importance of the pattern capable of reliably improving the accuracy of the access control policy to be high and making it easier to request input for the action.

Further, in a case in which it is possible to sequentially request the user to input the action associated with the pattern of the element not covered by the sample policy twice or more, the additional information request unit 215 can change the pattern of the element associated with the action of requesting the input in the second request after the first request in accordance with the content of the action input from the user in response to the first request. Accordingly, the policy generation system 21 can dynamically change the content of the input request depending on the situation, and thus can contribute to improvement in the accuracy of the access control policy.

Further, in a case in which it is possible to sequentially request the user to input the action associated with the pattern of the element not covered by the sample policy twice or more, the additional information request unit 215 may determine the degree of importance of the pattern of the element not covered on the basis of the number of input requests of an action which is necessary for having the reliability of the access control policy, which is generated using the sample policy and the action acquired by the input request to the user, and the pattern of the element associated therewith, to be equal to or greater than a predetermined threshold value. Accordingly, the policy generation system 21 can generate a highly reliable access control policy with a smaller number of additional information requests, and thus the cost required for policy generation can be reduced.

In addition, the totally ordered set indicating the degree of influence on the action may be defined for the pattern of the element, and the action may also be defined in the totally ordered set. The policy generation unit 213 can generate the access control policy so that the totally ordered set associated with the pattern of the element and the totally ordered set associated with the action become order-isomorphic. Accordingly, the policy generation system 21 can have the action determined in the access control policy to reflect the content of the action defined in the sample policy or the information of the intention.

Further, the additional information request unit 215 may present, to the user, information regarding the reliability of the access control policy generated using the sample policy, and the action acquired by the input request to the user, and the pattern of the element associated therewith. Accordingly, the policy generation system 21 can cause the user to determine whether the access control policy that can be generated so far has the sufficient reliability. Therefore, it contributes to the user's convenience.

Note that the present invention is not limited to the above example embodiments, and can be appropriately changed without departing from the gist.

For example, the following changes can be executed for the determination unit 22. As described above, the determination unit 22 determines the access control action when the request is made using the access control policy. Here, the determination unit 22 may not execute the process of acquiring the background attribute associated with the request with reference to the data store 23 each time the request is received. the determination unit 22 corrects a variable related to the background attribute of the access control policy acquired from the policy generation unit 213 to thereby reflect the current background attribute before the request is received. Accordingly, the determination unit 22 generates a temporary access control policy. As a result, unless the current background attribute is changed, when receiving the request, the determination unit 22 does not need to refer to the data store 23 in deciding an action, and may refer to an element in the request. As described above, when the request is received, the determination unit 22 can determine an action at a higher speed by executing the two steps of operation. In addition, since the process executed in a single request can be reduced, hardware of a control device on which the determination unit 22 is mounted can be made at low cost. Note that the temporary access control policy may be generated by the policy generation system 21 rather than the determination unit 22.

Here, the determination unit 22 may use only an element regarding an attribute of a packet header included in the request (for example, an IP address or a port number of at least one of the access source and the access destination) as data to be input to the temporary access control policy. Accordingly, a general firewall, a packet filter, a software defined network (SDN) switch, or a virtual local area network (V-LAN) as the enforcer 24 (access control device) can be used as the control device on which the determination unit 22 is mounted. Therefore, the device related to the determination unit 22 can be implemented with an inexpensive device.

In the example embodiments described above, the disclosure has been described as a hardware configuration, but the disclosure is not limited thereto. In the present disclosure, the process (steps) in the policy generation apparatus or the policy generation system explained in the above-described example embodiments can be also implemented by causing a processor in a computer to execute a computer program.

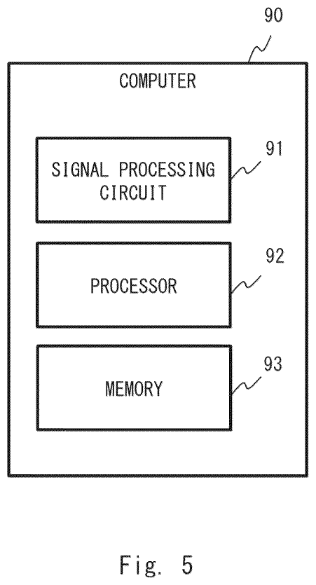

FIG. 5 is a block diagram illustrating a hardware configuration example of an information processing apparatus (signal processing apparatus) in which the processes in each example embodiment described above are executed. Referring to FIG. 5, an information processing apparatus 90 includes a signal processing circuit 91, a processor 92, and a memory 93.

The signal processing circuit 91 is a circuit for processing a signal under the control of the processor 92. The signal processing circuit 91 may include a communication circuit that receives a signal from a transmission apparatus.

The processor 92 is connected (coupled) to the memory 93, and reads and executes software (computer program) from the memory 93 to execute the processing in the apparatus described in the above-described example embodiments. As an example of the processor 92, one of a central processing unit (CPU), a micro processing unit (MPU), a field-programmable gate array (FPGA), a demand-side platform (DSP), or an application specific integrated circuit (ASIC) may be used, or a plurality of processors may be used in combination.

The memory 93 includes a volatile memory, a nonvolatile memory, or a combination thereof. The number of memories 93 is not limited to one, and a plurality of memories 93 may be provided. The volatile memory may be, for example, a random access memory (RAM) such as a dynamic random access memory (DRAM) or a static random access memory (SRAM). The nonvolatile memory may be, for example, a random only memory (ROM) such as a programmable random only memory (PROM) or an erasable programmable read only memory (EPROM), a flash memory, or a solid state drive (SSD).

The memory 93 is used to store one or more instructions. Here, one or more instructions are stored in the memory 93 as a software module group. The processor 92 can execute the processing described in the above-described example embodiments by reading and executing these software module groups from the memory 93.

Note that the memory 93 may include a memory built in the processor 92 in addition to a memory provided outside the processor 92. The memory 93 may include a storage disposed away from a processor configuring the processor 92. In this case, the processor 92 can access the memory 93 via an input/output (I/O) interface.

As described above, one or a plurality of processors included in each apparatus in the above-described example embodiments execute one or a plurality of programs including an instruction group for causing a computer to execute an algorithm described with reference to the drawings. With this processing, the signal processing method described in each example embodiment can be implemented.

The program includes a group of instructions (or software codes) for causing a computer to perform one or more functions that have been described in the example embodiments when the program is read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. As an example and not by way of limitation, the transitory computer-readable medium or the communication medium includes electrical, optical, acoustic, or other forms of propagated signals.

Although the present disclosure has been described above with reference to the example embodiments, the present disclosure is not limited to the above. Various modifications that could be understood by those skilled in the art can be made to the configuration and details of the present disclosure within the scope of the disclosure.

### REFERENCE SIGNS LIST

10 INFORMATION PROCESSING APPARATUS
11 ACQUISITION UNIT
12 REQUEST UNIT
20 ACCESS CONTROL SYSTEM
21 POLICY GENERATION SYSTEM
22 DETERMINATION UNIT
23 DATA STORE
24 ENFORCER
211 DETERMINATION SAMPLE ACQUISITION UNIT
212 INTENTION ACQUISITION UNIT
213 POLICY GENERATION UNIT
214 PARAMETER STORAGE UNIT
215 ADDITIONAL INFORMATION REQUEST UNIT

What is claimed is:

1. An information processing apparatus comprising:
at least one memory configured to store instructions; and
at least one processor configured to execute the instructions to:
acquire a data set in which a plurality of combinations of a pattern of a plurality of elements indicating an access attribute and an access control action associated with the pattern of the elements are defined; and
request a user to input an action associated with a pattern of an element not covered by the data set in a case in which the data set does not cover an action associated with one or more assumed patterns of an element.

2. The information processing apparatus according to claim 1, wherein, in a case in which there are a plurality of patterns of elements not covered by the data set, the at least one processor is further configured to determine the degree of importance of final action decision in the patterns of the elements not covered, and request the user to input at least an action associated with a pattern of an element with the highest degree of importance.

3. The information processing apparatus according to claim 2, wherein, in a case in which, in patterns of first and second elements not covered by the data set, when the action associated with the pattern of the first element is finally decided, a constraint condition of an action of the pattern of the second element is decided, but the reverse does not hold true, the at least one processor is further configured to determine that the pattern of the first element is higher in the degree of importance than the pattern of the second element.

4. The information processing apparatus according to claim 3, wherein the at least one processor is further configured to determine the degree of importance on the basis of at least one of the number of patterns of elements covered by the data set, an action acquired by an input request to the user, and a pattern of an element associated therewith, a ratio of the number of patterns of the elements covered to the number of one or more assumed patterns of the elements, or the reliability of an access control policy generated by using the data set, the action acquired by the input request to the user, and the pattern of the element associated therewith.

5. The information processing apparatus according to claim 2, wherein, in a case in which it is possible to sequentially request the user to input the action associated with the pattern of the element not covered by the data set twice or more, the at least one processor is further configured to change the pattern of the element associated with the action of requesting the input in a second request after a first request in accordance with the content of the action input from the user in response to the first request.

6. The information processing apparatus according to claim 5, wherein, in a case in which it is possible to sequentially request the user to input the action associated with the pattern of the element not covered by the data set twice or more, the at least one processor is further configured to determine the degree of importance on the basis of the number of input requests of an action which is necessary for having reliability of an access control policy, which is generated using the data set, the action acquired by the input request to the user, and the pattern of the element associated therewith, to be equal to or greater than a predetermined threshold value.

7. The information processing apparatus according to claim 1, wherein the at least one processor is further configured to generate an access control policy by using the data set, the action input from the user, and the pattern of the element associated therewith, wherein
a totally ordered set indicating the degree of influence on the action is defined for the pattern of the element, and the action is also defined by the totally ordered set, and
the at least one processor is configured to generate the access control policy so that the totally ordered set associated with the pattern of the element and the totally ordered set associated with the action become order-isomorphic.

8. The information processing apparatus according to claim 1, wherein the at least one processor is further configured to present, to the user, information regarding the reliability of the access control policy generated using the data set, the action acquired by the input request to the user, and the pattern of the element associated therewith.

9. An information processing method executed by a computer, the information processing method comprising:
acquiring a data set in which a plurality of combinations of a pattern of a plurality of elements indicating an access attribute and an access control action associated with the pattern of the elements are defined; and
requesting a user to input an action associated with a pattern of an element not covered by the data set in a case in which the data set does not cover an action associated with one or more assumed patterns of an element.

10. A non-transitory computer readable medium having a program stored therein, the program causing a computer to execute:
acquiring a data set in which a plurality of combinations of a pattern of a plurality of elements indicating an access attribute and an access control action associated with the pattern of the elements are defined; and
requesting a user to input an action associated with a pattern of an element not covered by the data set in a case in which the data set does not cover an action associated with one or more assumed patterns of an element.
